(19) United States
(12) Patent Application Publication
(10) Pub. No.: US 2010/0233668 A1
(43) Pub. Date: Sep. 16, 2010

(54) Dry erasable board in the form of a blister pack

(76) Inventors: Jeffrey L. Kelsoe, San Diego, CA (US); Mark Dobbs, Jackson Heights, NY (US)

Correspondence Address: Jeffrey L Kelsoe, 4444 Mississippi Street, San Diego, CA, 92116, US

(21) Appl. No.: 12/381,644

(22) Filed: Mar. 12, 2009

(51) Int. Cl. B43L 1/00; B23P 17/00

(52) U.S. Cl. 434/408; 29/592

(57) ABSTRACT

A dry erase board is provided wherein the erasable surface is vacuum-formed and heat sealed to a coated paper panel, forming a blister pack with a semi-rigid body. To this end, a dry erase board that is integral with its packaging is provided.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates generally to substrates that allow one to mark thereon. More specifically, the present invention relates to “dry erase” boards.

It is known to provide what is referred to as a dry erase board. A typical dry erase board includes a board or substrate that is coated with an enamel, film, ultraviolet cured liquid, liquid varnish, or porcelain finish. Specially designed markers are used to write on the substrate. While the ink of the marker dries on the substrate, the ink does not bond to the substrate and the writing can be easily removed with a soft eraser, cloth, finger, etc.

Many dry erase boards have been provided having a clear film and a substrate, allowing the placing of sheets between the clear film and the substrate. However, these dry erase boards are expensive to manufacture because the substrate must be attached to the clear film. Further, these dry erase boards require additional packaging for purposes of shipping and retail display, increasing the overall cost of the product.

U.S. Pat. No. 7,354,273 B2 discloses a dry erase board without a substrate. However, this board still requires additional packaging for shipping and display.

A need, therefore, exists for an improved dry erase board that eliminates the need for additional packaging as well as for special coatings, films or substrates.

### BRIEF SUMMARY OF THE INVENTION

The present invention provides improved dry erase boards that do not require a separate substrate or additional packaging for shipping or display purposes. The dry erase board of the present invention has a vacuum-formed erasable surface that is heat-sealed to a coated paper, thus creating a blister pack with a semi-rigid body. To this end, a dry erase board that is integral with its packaging is provided.

The dry erase board includes a front face having erasable characteristics and a back surface comprised of a coated paper panel capable of receiving printed indicia. The dry erase board further provides a standard dry erase marker sealed between the front and back surfaces of the body, a pull-tab for accessing and removing the marker, and a cavity for storing the marker.

The dry erase board is manufactured using a standard packaging process to vacuum-form and couple the front face to a coated paper panel, therein creating a sealed blister pack that serves as packaging for the product.

It is, therefore, an advantage of the present invention to provide a dry erase board in the form of a blister pack, thereby eliminating the need for additional retail packaging and individual shipping cartons.

Another advantage of the present invention is to provide a dry erase board that eliminates the need for a separate substrate.

Another advantage of the present invention is to provide a dry erase board that is easy to manufacture.

Another advantage of the present invention is to provide a dry erase board that is inexpensive to manufacture.

Another advantage of the present invention is to provide a dry erase board that will be the least expensive product of its kind on the market.

Other features and advantages of the present invention will become apparent after reviewing the drawings and the detailed description of the presently preferred embodiments.

### BRIEF DESCRIPTION OF THE SEVERAL VIEWS OF THE DRAWINGS

FIG. 1 illustrates a perspective view of a dry erase board in an embodiment of the present invention.

FIG. 2 illustrates a cross-sectional view of the continuous vacuum-formed beam that frames the front face of the dry erase board in FIG. 1 as shown along line C-C.

FIG. 3 illustrates a perspective view of the front side of the coated paper panel that comprises the back surface of the body of the dry erase board in FIG. 1.

FIG. 4 illustrates a perspective view of the back side of the coated paper panel shown in FIG. 3.

FIG. 5 illustrates a cross-sectional view of the included dry erase marker sealed between the vacuum-formed front cover of the dry erase board and the coated paper panel as shown along line B-B in FIG. 1.

FIG. 6 illustrates a cross-sectional view of the recessed storage cavity for the included dry erase marker as shown along line A-A in FIG. 1.

### DETAILED DESCRIPTION OF THE INVENTION

Improved dry erase boards are provided as well as methods of manufacturing the same.

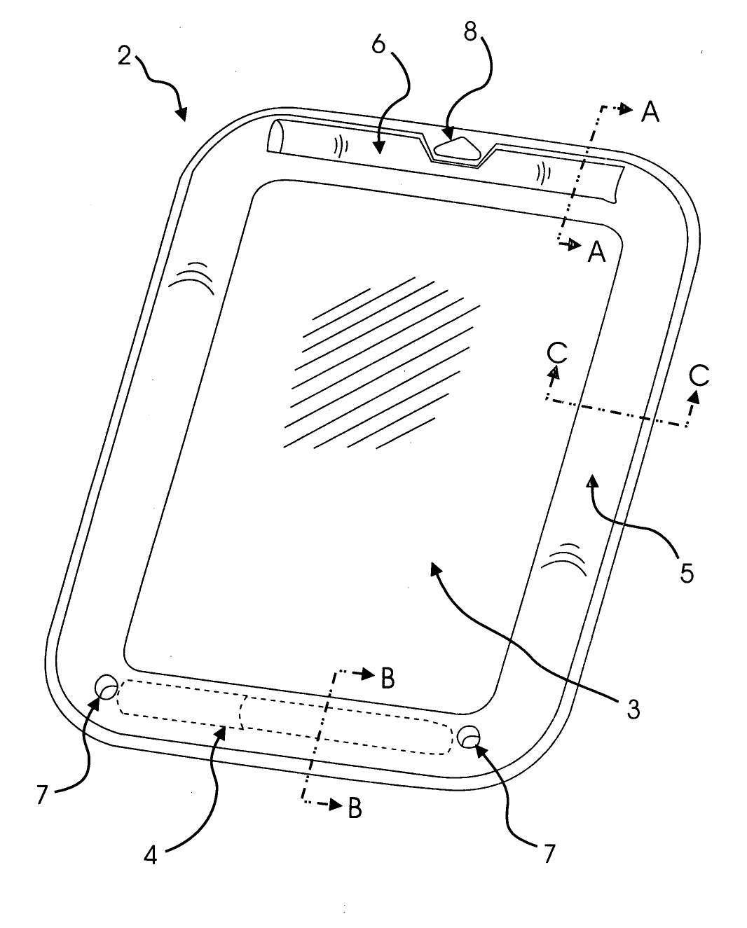

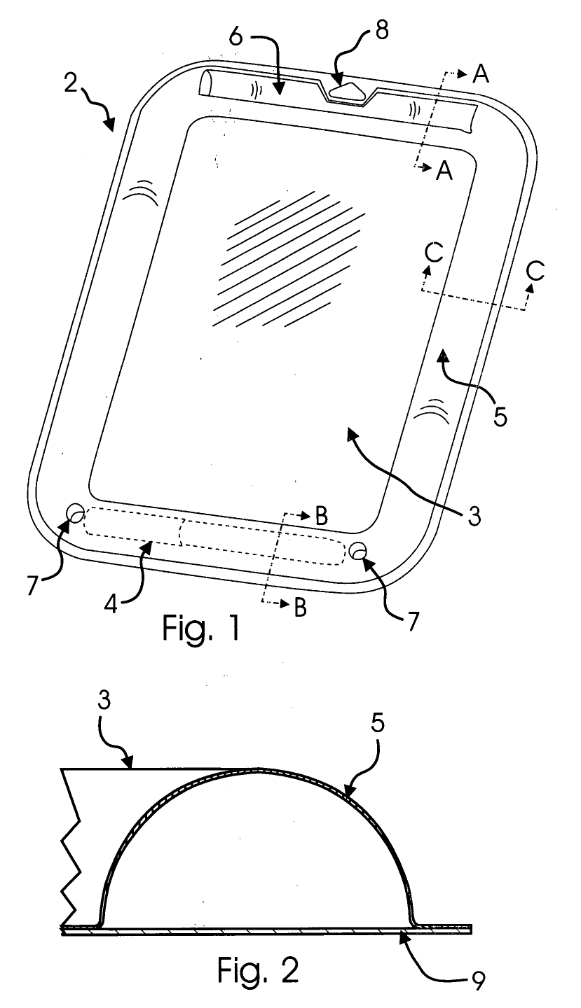

Referring to the figures, FIG. 1 illustrates an embodiment of the dry erase board 2 of the present invention. The dry erase board 2 has a semi-rigid body 2 in the form of a blister pack. The body 2 may have any shape. In an embodiment, the body 2 is rectangular in shape. A continuous vacuum-formed beam 5 (FIG. 2) frames the front face 3 of the body 2, providing rigidity.

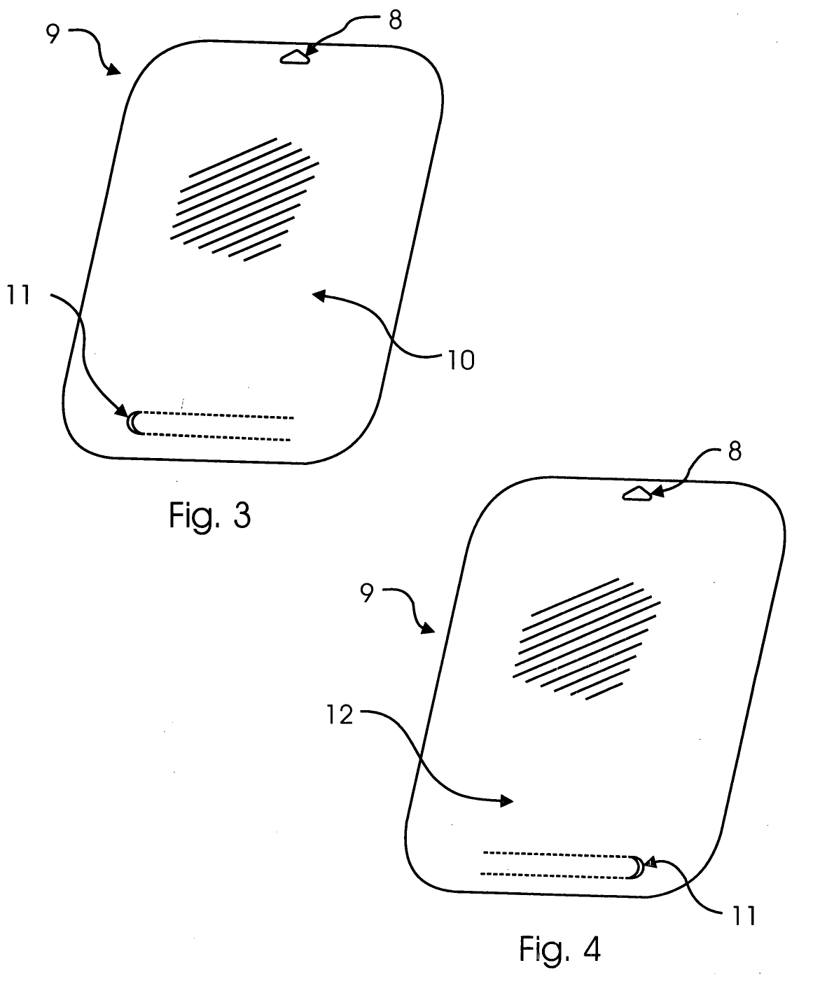

The front face 3 of the dry erase board 2 is heat-sealed to a coated paper panel 9 (FIGS. 3 and 4), creating a blister pack. To this end, a dry erase board 2 that is integral with its packaging is provided, thus eliminating the need for additional retail packaging and individual shipping cartons.

The dry erase board 2 is designed so that a user can write on the front face 3 of the body 2 with the included dry erase marker 4. Use of the dry erase marker 4 allows the writing to be conveniently removed.

The front face 3 of the dry erase board 2 is transparent and may consist of any material that has dry erase characteristics. For example, the front face 3 may comprise a PVC or PPE material or the like. Substrates, films or special coatings used by typical dry erase boards are not required.

The back surface of the dry erase board body 2 is comprised of a coated paper panel 9 (FIGS. 3 and 4). The front side 10 (FIG. 3) of the coated paper panel 9 may have indicia in the form of corporate logos, board game images (e.g., tic-tac-toe) or the like. The dry erase board 2 is designed so that these indicia are visible through the transparent front face 3 of the body 2. The back side 12 (FIG. 4) of the coated paper panel 9 may have printed product information, instructions for use or the like.

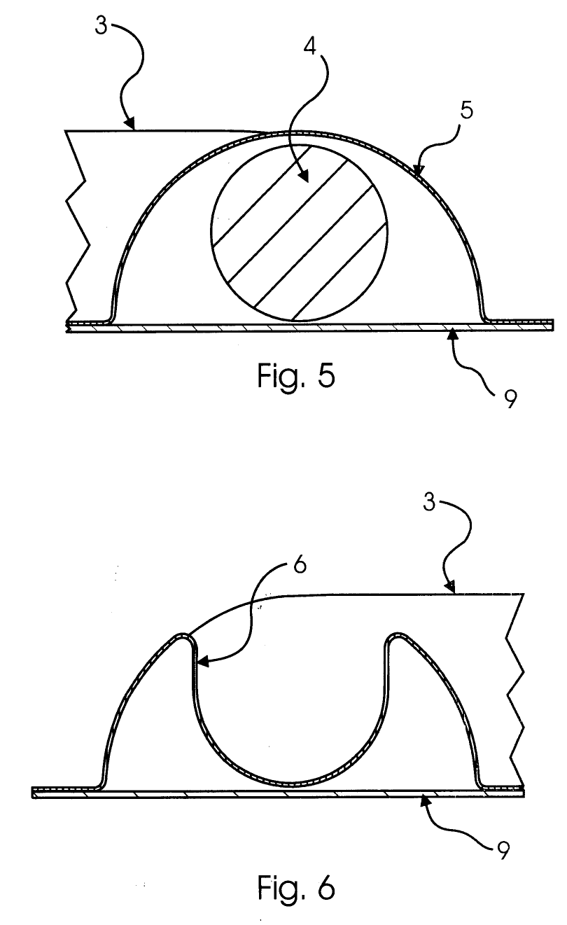

As shown in FIG. 5, the included dry erase marker 4 is sealed between the continuous beam 5 of the front face 3 and the coated paper panel 9. As shown in FIG. 1, a plurality of vacuum-formed features 7 are provided for aligning the dry erase marker 4 within the continuous beam 5. The dry erase board 2 provides a pull-tab 11 for accessing the marker 4 as well as a vacuum-formed recessed channel 6 (FIG. 6) on the front face 3 for storing the marker 4. In addition, the body 2 has at least one hole 8 along a side for the purpose of hanging the board.

FIG. 1 shows the dry erase board 2 in a finished state. The dry erase board 2 can be shipped to a user in this state, without need for additional packaging of any kind.

It will be understood by those skilled in the art that the above-presented description is provided by way of example only and is not intended to be limiting in any way. Those skilled in the art will readily understand that numerous other embodiments of the invention are contemplated and possible which meet the scope and spirit of the invention. It is therefore intended that all such contemplated and potential embodiments are covered by the appended claims.

The invention is claimed as follows:

1. A dry erase board comprising: a blister pack wherein the erasable surface is vacuum-formed and heat sealed to a coated paper panel, creating a semi-rigid body.

2. The dry erase board of claim 1, wherein the blister pack serves as packaging for the product.

3. The dry erase board of claim 1, wherein the dry erase board is shipped to a user in a finished state.

4. The dry erase board of claim 1, wherein the front face of the body comprises the dry erasable surface.

5. The dry erase board of claim 1, wherein a continuous vacuum-formed beam frames the front face of the body, providing rigidity.

6. The dry erase board of claim 1, wherein the entire front face is transparent.

7. The dry erase board of claim 1, wherein the back surface of the body is comprised of a coated paper panel.

8. The dry erase board of claim 1, wherein the body has at least one hole along a side for the purpose of hanging the board.

9. The dry erase board of claim 1, including a standard dry erase marker sealed between the front and back surfaces of the body.

10. The dry erase board of claim 1, providing a plurality of vacuum-formed features for aligning said dry erase marker within the continuous vacuum-formed beam that frames the front face.

11. The dry erase board of claim 1, providing a pull-tab feature for accessing said dry erase marker.

12. The dry erase board of claim 1, providing a vacuum-formed recessed channel on the front face for storage of said dry erase marker.

13. A method of manufacturing the dry erase board, the method comprising the steps of: providing a semi-rigid body comprised of dissimilar materials wherein the front face is comprised of a vacuum-formed transparent cover framed by a continuous beam and the back surface is comprised of a coated paper panel.

14. The method of claim 13, including the step of imprinting indicia on the top side of the coated paper panel so that the indicia are visible through the transparent front cover.

15. The method of claim 13, including the step of imprinting instructions for use and product information on the back side of the coated paper panel.

16. The method of claim 13, including insertion of a dry erase marker between the front cover and the back panel.

17. The method of claim 13, including coupling the front cover to the back panel by means of a heat sealing process and sealing a dry erase marker between them, therein creating a sealed blister pack that serves as packaging for the product.

18. The method of claim 13, wherein the dry erase board is shipped to a user in a finished state without need for additional retail packaging or individual shipping cartons.
